(19) United States
(12) Patent Application Publication
(10) Pub. No.: US 2026/0230787 A1
(43) Pub. Date: Aug. 6, 2026

(54) EMERGENCY CALL PROCESSING SYSTEM FOR VEHICLE

(71) Applicant: FUIT CO., LTD., Gwangju (KR)

(72) Inventor: SEHO KIM, Gimpo-si (KR)

(73) Assignee: FUIT CO., LTD., Gwangju (KR)

(21) Appl. No.: 19/432,104

(22) Filed: Dec. 23, 2025

Related U.S. Application Data
(63) Continuation-in-part of application No. 19/478,828, filed on Mar. 24, 2025.

(30) Foreign Application Priority Data
Sep. 19, 2024 (KR) 10-2024-0126811

(51) Int. Cl. H04W 4/90

(52) U.S. Cl. CPC H04W 4/90

(57) ABSTRACT

An emergency call processing system for a vehicle (100) according to an embodiment of the present invention includes: a device linkage unit (110) that performs a communication linkage with an emergency call (E-call) terminal (20) installed in the vehicle; a situation analysis unit (120) that analyzes an emergency situation or a preliminary emergency situation related to the vehicle or an occupant in the vehicle; a situation processing unit (130) that executes an operation for handling the emergency situation or the preliminary emergency situation according to predefined programming information when a pre-specified emergency situation or pre-specified preliminary emergency situation related to the vehicle or the occupant occurs; and a message generation unit (140) that generates a message related to the notification or response of the emergency situation or the preliminary emergency situation.

### CROSS REFERENCE TO PRIOR APPLICATIONS

This application is a Continuation-In-Part Application of U.S. patent application Ser. No. 19/478,828 filed on Oct. 26, 2025, which is a National Stage Application of PCT International Patent Application No. PCT/KR2025/003700 filed on Mar. 24, 2025, under 35 U.S.C. § 371, which claims priority to Korean Patent Application No. 10-2024-0126811 filed on Sep. 19, 2024, which are all hereby incorporated by reference in their entirety.

### BACKGROUND

The present invention relates to an emergency call processing system for a vehicle that is implemented to effectively respond to various emergency situations occurring in the vehicle and its occupants.

While telemetric systems are available to respond to emergencies in vehicles, services/solutions for certain shadow areas, such as deserts, are not available. Currently, there is a growing movement and demand for satellite-based services, particularly from companies in developed countries, such as Starlink. However, satellite communications are expensive and have limited bandwidth, making continuous satellite connectivity a burden.

Related prior art technologies include Korean Patent Laid-open No. 10-2022-0062939 (published on May 17, 2022), Korean Patent No. 10-1601534 (registered on Mar. 2, 2016), and Korean Patent Laid-open No. 10-2000-0013462 (published on Mar. 6, 2000).

### SUMMARY

The present invention provides an emergency call processing system for a vehicle that can effectively address various emergency situations, such as network instability in communication-dead zones such as deserts and mountainous terrain, vehicle risks due to disaster areas and situations, and emergency situations occurring to vehicle occupants.

According to an embodiment of the present invention, an emergency call processing system for a vehicle (100) according to an embodiment of the present invention may include: a device linkage unit (110) that performs a communication linkage with an emergency call (E-call) terminal (20) installed in the vehicle; a situation analysis unit (120) that analyzes an emergency situation or a preliminary emergency situation related to the vehicle or an occupant in the vehicle; a situation processing unit (130) that executes an operation for handling the emergency situation or the preliminary emergency situation according to predefined programming information when a pre-specified emergency situation or pre-specified preliminary emergency situation related to the vehicle or the occupant occurs; and a message generation unit (140) that generates a message related to the notification or response of the emergency situation or the preliminary emergency situation.

According to the emergency call processing system for a vehicle of the present invention, it is possible to respond to various emergency situations such as network instability in communication shadow areas including deserts and mountainous regions, vehicle hazards caused by disaster areas and situations, and emergencies occurring to vehicle occupants.

### BRIEF DESCRIPTION OF THE DRAWINGS

FIG. 1 is a block diagram illustrating an emergency call processing system for a vehicle according to an embodiment of the present invention.

FIG. 2 is a diagram illustrating emergency situation processing processes performed by the emergency call processing system for a vehicle illustrated in FIG. 1.

FIG. 3 is a diagram illustrating an E-call processing process in the case of an emergency pre-situation occurring in a high-frequency communication shadow area, according to an embodiment of the present invention.

FIG. 4 is a diagram for describing an E-call processing process in the case of an emergency pre-situation occurring during occupant risk pre-monitoring, according to an embodiment of the present invention.

### DETAILED DESCRIPTION OF THE INVENTION

Since the present invention may be variously modified and have several exemplary embodiments, specific exemplary embodiments will be shown in the accompanying drawings and be described in detail in a detailed description. However, it is to be understood that the present invention is not limited to the specific exemplary embodiments, but includes all modifications, equivalents, and substitutions included in the spirit and the scope of the present invention.

When it is determined that the detailed description of the known art related to the present invention may unnecessary obscure the gist of the present invention, a detailed description therefor will be omitted. In addition, numbers (for example, first, second, etc.) used in the description process of the present specification are only identification symbols for distinguishing one component from other components.

Further, throughout the present specification, it is to be understood that when one component is referred to as “connected to another component”, one component may be directly connected to another component or may be connected to another component through any other components unless explicitly described to the contrary. In addition, throughout the present specification, unless explicitly described to the contrary, “comprising” any components will be understood to imply the inclusion of other components rather than the exclusion of any other components. In addition, the term “unit”, “module”, or the like, described in this specification means a unit of processing at least one function or operation and may be implemented by hardware or software or a combination of hardware and software.

Hereinafter, exemplary embodiments of the present invention will be described in detail with reference to the accompanying drawings.

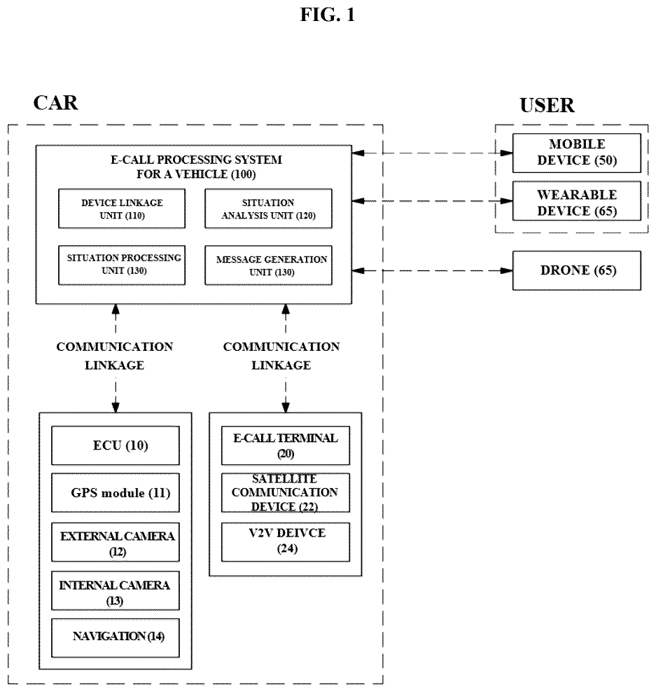

FIG. 1 is a block diagram illustrating an emergency call processing system for a vehicle according to an embodiment of the present invention.

Referring to FIG. 1, an emergency call processing system 100 for a vehicle according to an embodiment of the present invention may be configured to include: a device linkage unit 110 that performs communication linkage with an E-call (emergency call) terminal 20 installed in the vehicle; a situation analysis unit 120 that analyzes an emergency situation or preliminary emergency situation related to the vehicle or an occupant within the vehicle; a situation processing unit 130 that, when a pre-specified emergency situation or a pre-specified preliminary emergency situation related to the vehicle or the occupant occurs, executes operations to process the emergency situation or the preliminary emergency situation according to predefined programming information; and a message generation unit 140 that generates a message related to notification or response to the emergency situation or the preliminary emergency situation.

In an embodiment of the present invention, the device linkage unit 110 may be designed to enable communication linkage with a satellite communication device 22 installed in the vehicle, communication linkage with a mobile device 50 carried by the occupant or a wearable device 55 worn by the occupant, communication linkage with a vehicle-to-vehicle (V2V) device 24 that performs V2V communication with other vehicles in the vicinity of the vehicle, and communication linkage with drones in the vicinity of the vehicle.

Furthermore, the device linkage unit 110 may be designed to enable communication linkage between devices installed in the vehicle, such as an electronic control unit (ECU) 10, a GPS module 11, an external camera device 12, an internal camera device 13, and a navigation terminal 14.

In an embodiment of the present invention, the situation analysis unit 120 may determine whether the pre-specified emergency situation or the pre-specified preliminary emergency situation occurs through data analysis based on vehicle status information (e.g., shock waves, vehicle malfunction check, monitoring data from before a problem occurs to a problem occurrence point, etc.) and vehicle operation information acquired from the ECU 10, vehicle location information acquired from the GPS module 11, vehicle external environment information acquired from the external camera device 12, accident information on the vehicle's operation route acquired from the navigation terminal 14, driver status information and passenger status information as occupant status information acquired from the internal camera device 13, and occupant status information acquired from a wearable device 52.

Hereinafter, the processing operations of the emergency call processing system 100 for a vehicle according to an embodiment of the present invention will be described by distinguishing between emergency situation occurrence cases and preliminary emergency situation occurrence cases.

### Basic Processing Method for Emergency Situation Cases

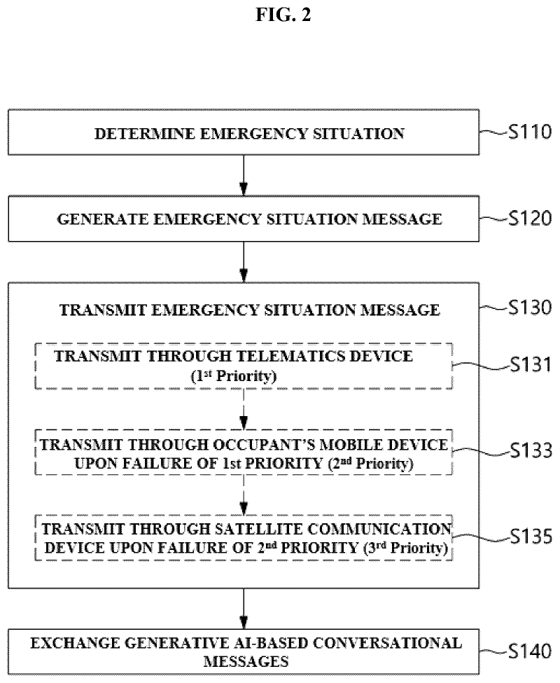

FIG. 2 is a diagram illustrating emergency situation processing processes by the emergency call processing system for a vehicle illustrated in FIG. 1.

In an embodiment of the present invention, when the emergency situation is determined to have occurred based on the analysis results of the situation analysis unit 120 (S110 of FIG. 2), the situation processing unit 130 may generate an emergency situation notification message using vehicle location information acquired from the GPS module 11 as basic information, and includes at least one of vehicle status information and vehicle operation information acquired from the ECU 10, vehicle external environment information acquired from the external camera device 12, vehicle operation route information acquired from the navigation terminal 14, and satellite image information surrounding the vehicle acquired from the satellite communication device 22 as additional information (S120 of FIG. 2); and transmit the emergency situation notification message to the vehicle information control center server or the emergency salvage/rescue service center server (S130 of FIG. 2).

Here, the emergency situation may be pre-specified, and as a first case, refers to an accident occurring to the vehicle itself, and may include, for example, the occurrence of a vehicle impact exceeding a threshold (a more specific example may be airbag activation due to a vehicle collision), an abnormal vehicle stoppage, etc. Of course, various other emergency situations may be specified according to the definition.

Additionally, as a second case of the emergency situation, there may be an emergency situation that occurs to an occupant (driver or passenger) inside the vehicle, regardless of a vehicle accident.

For example, when the health/consciousness of the driver or passenger is identified as a dangerous situation through analysis of audio/video captured through the vehicle's internal camera, or voice/sound/video/biosignals acquired through mobile or wearable devices, this may be designated as an emergency situation within the second case.

More specifically, examples of dangerous situations include the occurrence of voice/sound intensities exceeding a threshold through voice tracking, the occurrence of anxious/surprised facial expressions through face tracking, or the occurrence of an abnormal heart rate. In such cases, the situation processing unit 130 may transmit an emergency E-call message and take measures to ensure the occupant's psychological stability or alleviate the health/consciousness risk through generative AI-based text or voice messages until rescue vehicles/rescue personnel arrive (S140 of FIG. 2).

As described above, when it is determined that the emergency situation has occurred, the situation processing unit 130 may externally transmit a notification message of the emergency situation according to the following order of E-call processing priorities. Of course, it is obvious that the E-call processing priorities described below may also be appropriately modified depending on the system design method.

In one embodiment, the situation processing unit 130 may use the E-call terminal 20 as a first-priority transmission device when transmitting an emergency situation notification message to the outside (S131 of FIG. 2), and when the E-call terminal 20 is unable to communicate or the message transmission through the E-call terminal 20 is not smooth depending on the communication network situation, determine the mobile device 50 (e.g., a smartphone, etc.) of the occupant as a second-priority transmission device through the device linkage so that the message transmission is performed through the mobile device 50 (e.g., a smartphone, etc.) (S133 of FIG. 2), and when the mobile device 50 is also unable to communicate or the message transmission through the mobile device 50 is not smooth depending on the communication network situation, and determine the satellite communication device 22 as a third-priority transmission device through the device linkage so that the message transmission is performed through the satellite communication device 22 (S135 of FIG. 2).

That is, according to the emergency call processing system 100 for a vehicle according to an embodiment of the present invention, when the vehicle is in a communication shadow area at the time when the emergency notification message should be transmitted externally and the signal from the base station-based E-call terminal 20 is not detected, the system connects to a mobile device 50 (occupant, i.e., driver or passenger) such as a smartphone with a previous connection history to determine whether communication is possible in the event of an emergency. When the occupant's mobile device 50 also fails to receive a signal, the system may request the user's consent to attempt a satellite connection in preparation for an emergency, and after obtaining the consent, attempt to establish a satellite connection. When the communication with the satellite is difficult due to a communication system issue, the system may notify the driver of the emergency and warn the driver to take appropriate emergency preparedness measures.

While the present invention may significantly alleviate the communication shadow issue by utilizing the satellite communication device 22, situations where communication is not smooth may still occur, even with satellites. Therefore, in an embodiment of the present invention, the following service scenario is applied, assuming a situation where satellite communication conditions are poor.

In one embodiment, when transmitting an emergency situation notification message via the satellite communication device, if the satellite communication signal sensitivity is less than a pre-specified first threshold and thus satellite communication conditions are poor, the situation processing unit 130 may process a received voice message from the occupant notifying the emergency situation to be converted into text and generated through the message generation unit.

Furthermore, when the satellite communication signal sensitivity is less than a pre-specified second threshold, which is set to be lower than the first threshold, and thus, the satellite communication conditions are poor, the situation processing unit 130 may convert the received voice message from the occupant into text and then analyze the content of the entire converted text so that only a single situation representative word, representing the emergency situation according to the entire text content, is included in the message generated through the message generation unit, thereby minimizing the data volume of the transmitted message.

### Emergency Rescue Method in Emergency Situation Occurrence Cases

When the emergency situations as described above occur, the situation processing unit 130 according to an embodiment of the present invention may transmit an emergency situation notification message to a remote vehicle information control center server and/or an emergency salvage/rescue service center server, thereby enabling emergency situation processing (i.e., vehicle rescue, occupant rescue, emergency medical services, etc.).

However, depending on the situation, standard emergency situation processing procedures may make it difficult to promptly handle an emergency situation (e.g., remote dispatch, lack of operational personnel for emergency response, etc.). To address such situations, a service may be implemented that allows individuals with specific qualifications, such as emergency medical technicians or doctors, to register their qualifications in advance, so that, in the event of an accident, a message may be sent to registered personnel in the vicinity, enabling rapid emergency rescue and treatment.

To this end, in one embodiment of the present invention, the situation processing unit 130 processes the emergency situation notification message to be transmitted to at least one of a remote vehicle information control center server, an emergency salvage/rescue service center server, and other vehicles or other peoples in the vicinity.

When, based on geographic or temporal accessibility, a pre-registered qualified individual who is qualified to provide emergency salvage/rescue services or emergency medical services has top priority access to the vehicle in which the emergency situation occurred, the situation processing unit 130 notifies the qualified individual of the emergency situation through a communication link with the vehicle information control center server or the emergency salvage/rescue service center server, or through a direct communication link with the pre-registered qualified individual, thereby enabling the qualified individual to provide emergency salvage/rescue services or emergency medical services.

### Preliminary Emergency Situation Occurrence—High-Frequency Communication Shadow Area Case

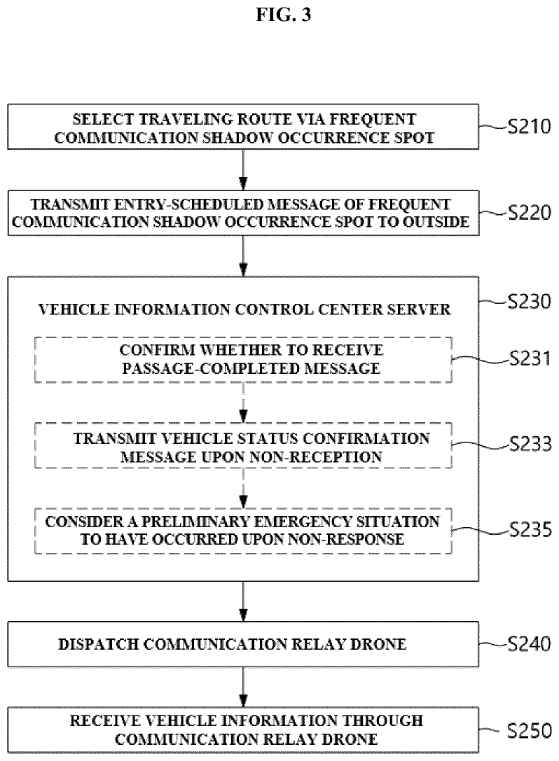

FIG. 3 is a diagram illustrating the E-call processing process when the preliminary emergency situation occurs in a high-frequency communication shadow area case, according to an embodiment of the present invention.

When the above-described emergency situation occurs in a communication shadow area, the emergency notification and processing via base station-based E-call terminals and/or occupant mobile devices may become impossible.

To address this situation, the embodiments of the present invention may implement a system that operates as a preliminary management/monitoring system for emergency situations by pre-registering spots where communication shadows frequently occur.

To this end, in one embodiment, when the vehicle's traveling route (on the actual traveling route or on a traveling route selected by the navigation system) passes through a pre-registered frequent communication shadow occurrence spot (S210 of FIG. 3), the situation processing unit 130 processes such that an entry-scheduled message is transmitted externally via the E-call terminal at a predetermined point in time before the vehicle enters the frequent communication shadow occurrence spot (S220 of FIG. 3), thereby enabling the preliminary emergency situation monitoring function to be performed.

In this case, vehicle information-related data such as location, time, vehicle identification information, and vehicle speed at that point in time may be inserted into the entry scheduled message.

Furthermore, the situation processing unit 130 may process a passage-completed message to be transmitted externally via the E-call terminal at a predetermined point in time after the vehicle passes the frequent communication shadow occurrence spot, thereby enabling the preliminary emergency situation release function to be performed.

Accordingly, when the passage-completed message is not received until the expected passage time for passing through the frequent communication shadow occurrence spot has elapsed (S231 of FIG. 3), based on the pre-specified expected passage time calculation criteria (for example, based on the speed limit for the road, the vehicle speed at the entry point included in the entry-scheduled message, a pre-set validity period considering the typical expected passage time, etc.) after receiving the entry-scheduled message, the remote vehicle information control center server that received the entry-scheduled message may transmit at least a one-time vehicle status confirmation message to the E-call terminal (S233 of FIG. 3), and when no response is received to the vehicle status confirmation message, the remote vehicle information control center server may consider that the preliminary emergency situation has occurred in the vehicle (S235 of FIG. 3).

In such a case, the vehicle information control center server may dispatch a communication relay drone to the frequent communication shadow occurrence spot, thereby allowing the drone to confirm the actual status and location of the vehicle (S240 of FIG. 3).

That is, this is because it is necessary to determine whether the actual communication shadow has occurred and whether the emergency situation (e.g., a vehicle accident) has occurred in the vehicle while the communication shadow has occurred, or whether the communication shadow has occurred but the vehicle is in a temporarily stationary and calm state.

Based on the vehicle information included in the entry-scheduled message, when the vehicle is identified by the communication relay drone, the vehicle information control center server may obtain at least one of the vehicle's location information and image information directly identified by the communication relay drone, or at least one of the vehicle status information and occupant status information identified through the communication link between the communication relay drone and the mobile device of the vehicle's occupant directly from the communication relay drone or the communication relay via a satellite communication system (S250 of FIG. 3).

Accordingly, based on the information obtained as described above, the vehicle information control center server may determine whether the vehicle is in an actual emergency situation, and when an actual emergency situation occurs, process actions such as emergency salvage/rescue.

### Preliminary Emergency Situation Occurrence-Occupant Risk Preliminary Monitoring Case

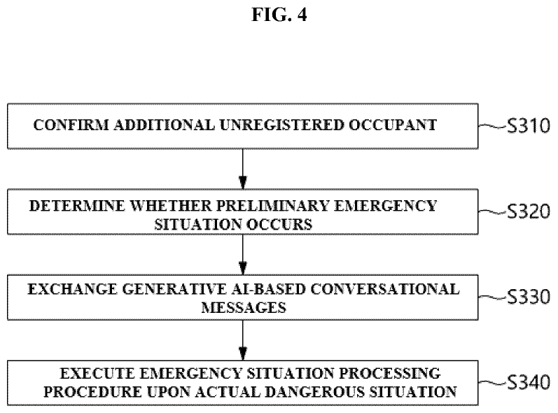

FIG. 4 is a diagram illustrating the E-call processing process when an emergency preliminary situation occurs in an occupant risk preliminarily monitoring case, according to an embodiment of the present invention.

Emergencies that arise for occupants typically occur from vehicle accidents, or develop into critical situations unrelated to the accident, due to the occupant's mental or physical condition.

These common emergency situations may be handled using the methods described above. However, in addition to these common cases, there are also exceptional cases where an occupant's safety is threatened by others.

As a method for preparing for an emergency situation caused by a threat from another person as described above, in an embodiment of the present invention, the situation analysis unit 120 may, based on data obtained from at least one of an electronic control unit (ECU) and a navigation terminal installed in the vehicle, determine whether there is an occupant who has additionally boarded the vehicle after the vehicle stops at a location unrelated to the vehicle's driving destination, and whether the information of the additional occupant identified by short-range communication with the mobile device of the additional occupant corresponds to an unregistered occupant who has not been registered in a pre-registered occupant list (S310 of FIG. 4).

When it is confirmed that an unregistered occupant is on board, the situation analysis unit 120 may perform a procedure for analyzing whether a dangerous situation involving the occupant has occurred, based on monitoring data derived from at least one of audio and video data acquired by the internal camera device, traveling route data acquired by the navigation terminal, and biometric data of the existing occupant acquired by the occupant's mobile device or wearable device (see FIG. 4, step S320).

In one embodiment, the situation analysis unit 120 may determine that the preliminary emergency situation has occurred if at least one of the following occurs: 1) a change in the destination route through the navigation terminal occurs or a route deviation frequency that deviates from the existing destination traveling route occurs more than a predetermined number of times after the unregistered occupant boards, 2) a loud noise exceeding a predetermined threshold is generated based on audio data acquired by the internal camera device, 3) a dangerous situation occurs based on face recognition or dangerous material is extracted based on object recognition based on video data acquired by the internal camera device, or 4) biometric data in an abnormal range is acquired based on the occupant's biometric data acquired by the existing occupant's mobile device or wearable device.

In the case described above, in the embodiment of the present invention, the situation processing unit 130 may perform a confirmation procedure to confirm whether the threat by the unregistered occupant has actually occurred.

For example, the situation processing unit 130 may enable a message exchange based on generative artificial intelligence (AI) with an existing occupant, such as a driver or passenger, but may use a deceptive message (including a pre-arranged query that allows the existing occupant to recognize the confirmation procedure) to determine whether the threat has actually occurred (S330 of FIG. 4); and when it is determined that the threat has actually occurred, transmit the emergency situation notification message to the outside via the E-call terminal (S340 of FIG. 4).

As a more specific example, when it is confirmed that the emergency situation occurs, the situation analysis unit 130 may also transmit an emergency situation notification message to the outside so that a police vehicle or rescue vehicle arrives at the specific point after displaying a sign (e.g., deceiving the fuel warning light display through linkage with an ECU) that deceives the driver into passing through a specific point (e.g., a gas station, etc.) located on the current traveling route or the changed destination route.

Although the embodiments of the present invention have been described hereinabove, it may be understood by those skilled in the art that the present invention may be variously modified and altered without departing from the scope and spirit of the present invention described in the following claims.

### Other Emergency Situation Processing Methods

In addition to the emergency situation or preliminary emergency situation processing methods described above, other emergency situation processing methods may also be implemented in the present invention.

In one embodiment, when an emergency situation occurs to the vehicle or an occupant while the E-call terminal (20) is in a communication-disabled state, the situation processing unit (130) may process such that an emergency message is transmitted by utilizing a communication relay drone provided in the vehicle.

More specifically, the device linkage unit (110) establishes short-range communication linkage between the communication relay drone and the E-call terminal (20), and the communication relay drone acquires emergency message information including GPS-based current location information and accident information from the E-call terminal (20). Thereafter, the communication relay drone autonomously flies to a location outside the communication-disabled area and performs transmission of the emergency message.

In another embodiment, when accident situation information occurring ahead on a vehicle traveling route is received by the device linkage unit (110) through vehicle-to-vehicle (V2V) communication or vehicle-to-infrastructure (V2I) communication, the situation processing unit (130) may provide the occupant with at least one of driving information, route information, and preparedness information for avoiding the accident situation based on a large language model (LLM).

What is claimed as:

1. An emergency call processing system for a vehicle, comprising:
a device linkage unit that performs a communication linkage with an emergency call (E-call) terminal installed in the vehicle, a communication linkage with a satellite communication device installed in the vehicle, a communication linkage with a mobile device carried by an occupant in the vehicle, and a communication linkage with other vehicles or drones in the vicinity of the vehicle;
a situation analysis unit that analyzes an emergency situation or preliminary emergency situation related to the vehicle or the occupant;
a situation processing unit that, when a pre-specified emergency situation or a pre-specified preliminary emergency situation related to the vehicle or the occupant occurs, executes an operation to process the emergency situation or the preliminary emergency situation according to predefined programming information; and
a message generation unit that generates a message related to notification or response to the emergency situation or the preliminary emergency situation.

2. The emergency call processing system of claim 1,
wherein the situation processing unit is configured to transmit an emergency message by utilizing a communication relay drone provided in the vehicle when the emergency situation occurs to the vehicle or the occupant while the E-call terminal is in a communication-disabled state.

3. The emergency call processing system of claim 2,
wherein the situation processing unit is configured to:
establish, through the device linkage unit, a short-range communication connection between the communication relay drone and the E-call terminal when the emergency situation occurs to the vehicle or the occupant while the E-call terminal is in a communication-disabled state;
allow the communication relay drone to acquire emergency message information including GPS-based current location information and accident information from the E-call terminal; and
allow the communication relay drone to perform transmission of the emergency message at a location outside the communication-disabled area through autonomous flight.

4. The emergency call processing system of claim 1,
wherein, when accident situation information occurring ahead on a vehicle traveling route is received by the device linkage unit through vehicle-to-vehicle (V2V) communication or vehicle-to-infrastructure (V2I) communication,
the situation processing unit is configured to provide the occupant with at least one of driving information, route information, and preparedness information for avoiding the accident situation based on a large language model (LLM).
